(19) United States
(12) Patent Application Publication
(10) Pub. No.: US 2010/0061118 A1
(43) Pub. Date: Mar. 11, 2010

(54) Lens Beam-Concentrating Device

(76) Inventor: Keh-Shium LIU, Hsinchu City (TW)

Correspondence Address: Dr. BANGER SHIA, 102 Lindencrest Ct., Sugar Land, TX, 77479-5201, US

(21) Appl. No.: 12/207,485

(22) Filed: Sep. 9, 2008

(51) Int. Cl. F21V 8/00

(52) U.S. Cl. 362/617

(57) ABSTRACT

A lens beam-concentrating device comprises at least one light-emitting diode light source disposed on a lateral edge of a light guide plate. The light source emits light rays toward the light guide plate, after the light rays are directed by the light guide plate, a parallel light beam will emit from an emission surface of the light guide plate to form a plane light source. A first lens element and a second lens element are arranged in front of the light emission surface of the light guide plate for adjusting and collimating the parallel beam, so as to ensure the light rays to emit out of the beam-concentrating device parallel to each other.

### BACKGROUND OF THE INVENTION

1. Field of the Invention

The present invention relates to a beam-concentrating device, and more particularly to a lens beam-concentrating device, which can provide an evenly-distributed, highly-focused and intensified parallel light beam and control the projection plane of the parallel light beam.

2. Description of the Prior Art

Besides common illumination equipments, conventional illumination systems also include devices or structures for centralizing beams of light, adding beams of light or producing parallel light beams such as:

U.S. Pat. No. 7,354,178 discloses that plural LED (light-emitting diode) light sources are placed in a flat structure, and each of the light sources is formed at the periphery thereof with a reflective structure in the form of an elongated notch, and the light rays emitting from the light sources form a plane light source or a light beam by reflection of the reflective structures, and the half value fill angle is about within the range of ±12 degrees, which cannot achieve the optimal light concentration effect yet. Further, U.S. Pat. No. 6,819,505 discloses that a lens is additionally provided on an optical path of the light source for adjusting the optical path of light rays emitting from a light source by refraction and total internal reflection. Additionally, U.S. Pat. No. 6,932,490 discloses that a reflective mirror is arranged around a central light source, a convex lens is additionally provided in the middle of the optical path, so as to adjust the light rays in the center of the beam of light. However, such an adjustment through the independent lens or a re-adjustment through the reflective mirror cannot concentrate and collimate the light rays around the beam of light yet to reduce the half value full angle of the output light rays smaller than the level of ±5 degrees. Therefore, improvement is required.

In addition, JP Patent No. H08-107235 discloses that a bulb is exteriorly provided with a curved reflective mirror, and the curved reflective mirror is provided with a projection lens at the big-diameter opening thereof and a light source at the center thereof, the light source radiates divergent light rays toward the reflective mirror, and then the divergent light rays will be directed by the lens to form a beam of light, however, since only one single lens is used, the adjustment effect is very limited. U.S. Pat. No. 7,111,964, that is essentially improved from the above JP Patent. No. H08-107235, discloses that a light-emitting diode is used as a light source, and a lens is provided for directing light, so that the lens can directly output a parallel beam of light, or a reflective surface is additionally provided for enlarging the projection plane of the beam of light. U.S. Pat. No. 6,547,423 relates to a design of a single lens cooperated with a light source, such designs all utilize a single lens which has very limited ability of adjusting the beam of light to adjust the beam of light, which emits from a small area of light source or a single light source. Moreover, since such designs all try to utilize a special designed curve of the lens to guide the diverge light rays to form a beam of light with a uniform projection plane, the light guide angle of the respective reflection points or the light penetration points must be quite definite, or else it is likely to cause the loss of the light beam due to diffusion or impossible to keep light rays parallel to each other. Hence, the effect of guiding and concentrating light rays is quite limited, so improvement is substantially required.

The present invention has arisen to mitigate and/or obviate the afore-described disadvantages.

### SUMMARY OF THE INVENTION

The primary objective of the present invention is to provide a lens beam-concentrating device comprising plural LED light sources disposed on a lateral edge of a light guide plate. After being directed by the light guide plate, the light rays emitted from the light emission surface of the light guide plate is converted into a parallel light beam in the form of a plane light source. A first lens element and a second lens element are in order arranged in front of the light emission surface of the light guide plate for diverging or converging the light rays, so that the accuracy of the light beam emitting from the beam-concentrating device is increased, the parallelization of the respective light rays of the light beam is the optimal, the loss of the light rays is greatly reduced, thus providing the high quality and centralized light beam. By such arrangements, the half value full angle of the light rays emitting from the light emission surface, which is within 0-10 degrees, will be reduced within 0-3 degrees after the light rays pass through the at least two lens elements.

The secondary objective of the present invention is to provide a lens beam-concentrating device comprising a first lens element in the form of a concave lens element and a second lens element in the form of a convex lens element. With the cooperation between the concave and convex lens elements, the parallel light beam emitting from the light guide plate can be diverged and converged, so as to readjust the area and the centralization of the light beam more than two times, thus providing the high quality and centralized light beam.

The third objective of the present invention is to provide a lens beam-concentrating device comprising a first lens element and a second lens element that are both in the form of a convex lens element. With the cooperation between the two lens elements, the parallel light beam emitting from the light guide plate can be diverged and converged, so as to readjust the area and the centralization of the light beam more than two times, thus providing the high quality and centralized light beam.

### BRIEF DESCRIPTION OF THE DRAWINGS

FIG. 1 is a cross-sectional view of a lens beam-concentrating device in accordance with the present invention;

FIG. 2 is a schematic view illustrating a large-area end surface of a light guide plate in accordance with the present invention;

FIG. 3 is a schematic view illustrating a large-area end surface of a light shielding element in accordance with the present invention;

FIG. 4 is a schematic view illustrating the optical path of the light rays in accordance with the present invention when the two lens element are a concave and a convex lens element, respectively; and

FIG. 5 is a schematic view illustrating that illustrating the optical path of the light rays in accordance with the present invention when the two lens elements are both a convex lens element.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

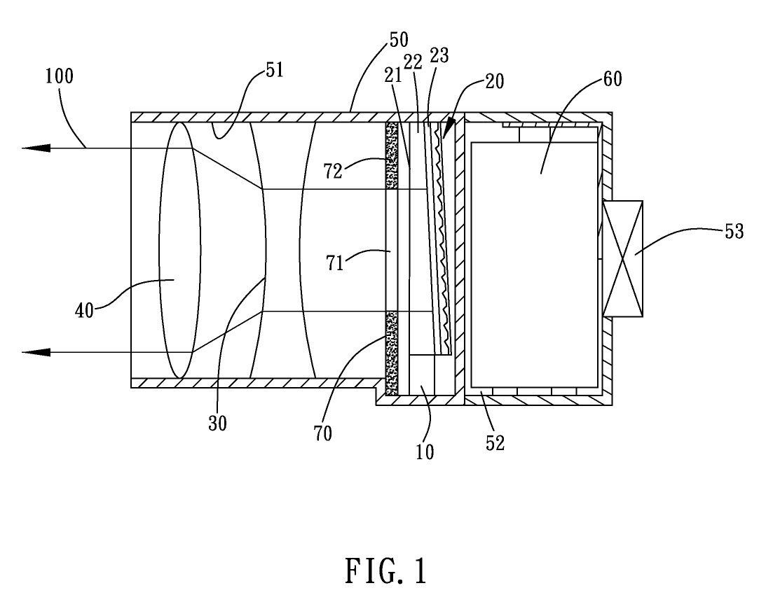

Referring to FIG. 1, a lens beam-concentrating device in accordance with the present invention comprises plural LED light sources 10, which are arranged on a lateral edge of a light guide plate 20. The light guide plate 20 has one end formed with an emission surface 21 for emission of the light rays 100 emitting from the light sources 10. The lens beam-concentrating device in accordance with the present invention is provided with a first lens element 30 and a second lens element 40 in front of the light emission surface 21 along an optical path where the light rays 100 pass. When the light rays 100 pass through the first lens element 30 and the second lens element 40, the optical path of the light rays 100 will be adjusted more than one time, so as to form a parallel light beam that is evenly distributed and highly focused and intensified. Furthermore, the half value full angle of the light rays 100 emitting from the light emission surface 21 of the light guide plate 20 is approximately within 0-10 degrees. The half value full angle of the light rays 100 that have passed through the two lens elements 30, 40 is approximately within 0-3 degrees.

The above elements are all arranged in a housing 50 including a long hollow chamber 51 having a receiving space with an opening through which the light rays 100 emit out of the housing 50. The light sources 10, the light guide plate 20, the first lens element 30 and the second lens element 40 are, in order from inside to outside, arranged in the chamber 51.

The housing 50 is further provided with a power supply room 52 adjacent to the chamber 51 for accommodation of a battery power supply 60. The power supply 60 is exteriorly connected with a switch 53 for the user to control the on/off of the light sources 10.

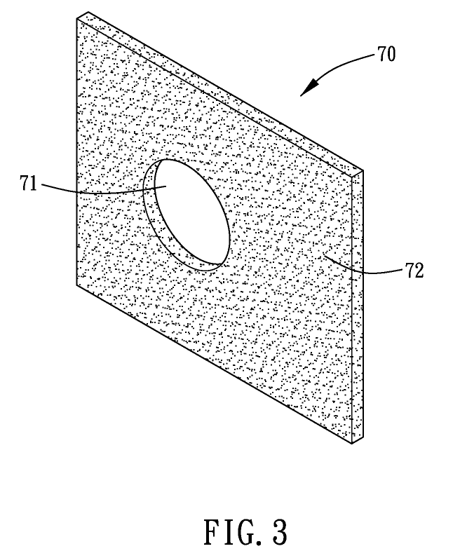

Between the light guide plate 20 and the first lens element 30 is additionally provided a light shielding element 70. As shown in FIG. 3, the light shielding element 70 includes a central light-transmission portion 71 and a light shielding portion 72 around the central light-transmission portion 71. The light shielding element 70 is made of a light-proof material or a light-transmitting material. The light-transmitting material can be a glass material, acrylic material or other transparent materials. The light-proof material can be a dark plastic material, an opaque metal material or nonmetal material. The light shielding portion 72 is coated with black paint or directly made of light-proof material to block light rays. The light-transmission portion 71 is made of transparent glass or in the form of a through hole for passage of the light rays 100, so that the effective light beam can be adjusted and collimated by the two lens elements 30, 40 after passing therethrough, thus providing a high-quality and high-accuracy light beam.

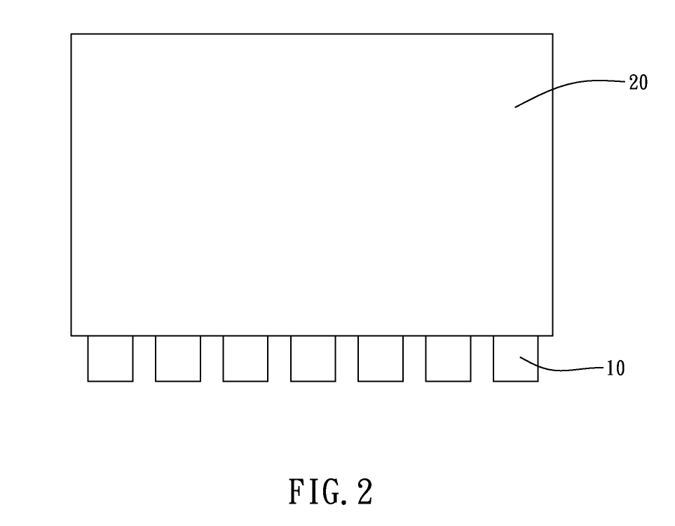

Referring to FIG. 2, the light guide plate 20 is a square sheet body. As shown in FIG. 1, the light emission surface 21 is arranged on one large-area end surface of a total internal reflection layer 22, and one large-area end surface of a reflection layer 23 is arranged to abuts against the other large-area end surface of the total internal reflection layer 22. The other large-area end surface of the reflection layer 23 can be designed to be inclined or provided with a protruding reflective structure for enabling the light rays 100 which are directed from the total internal reflection layer 22 to the reflection layer 23 to emit from the light emission surface 21 parallel to each other, thus forming a parallel light beam extending parallel to the optical axis of the present invention.

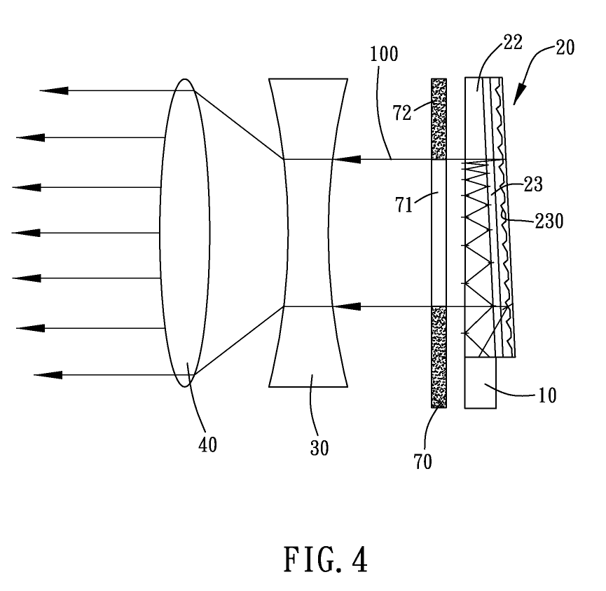

As shown in FIG. 4, the first lens element 30 is a concave lens element for converting the parallel beam of light rays 100 into a divergent light beam which will be collimated by the second lens element 40 to form a parallel light beam again extending parallel to the optical axis of the present invention. By such arrangements, the collimated beam angle of the respective light rays 100 of the parallel light beam emitting from the light guide plate 20 relative to the optical axis of the present invention, which is within the range of ±3 degrees can be reduced to the level of ±1 degree after adjustment and collimation of the first lens element 30 and the second lens element 40, namely when the light rays 100 emit from the light guide plate 20, the half value full angle is within 0-10 degrees, and after the light rays 100 are adjusted and collimated by the first lens element 30 and the second lens element 40, the half value full angle will be reduced within 0-3 degrees.

In the preferred embodiment of the present invention, the first lens element 30 is a concave lens element with a focal length f1, and the second lens element 40 is a convex lens with a focal length f2, wherein if f1=−(⅓)f2, the distance between the first lens element 30 and the second lens element 40 is (⅔)f2, the output light beam enlarges 3 times while the beam angle is reduced to be one third of the original beam angle of the light rays 100 emitting from the light guide plate 20, and the light intensity per unit area decreases to one third of the light intensity of light rays emitting from the light guide plate 20. Therefore, the closer the light guide plate 20 is to the first lens element 30 and the second lens element 40, the better. Moreover, adjusting the distance between the first lens element 30 and the second lens element 40 can enlarge the projection plane of the overall parallel light beam and reduce the light intensity while improving the accuracy of the beam angle.

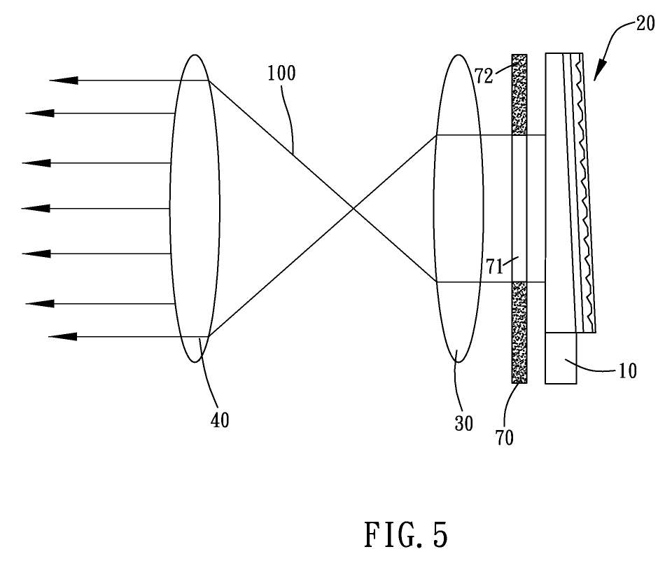

Further referring to FIG. 5, the first lens element 30 and the second lens element 40 are both a convex lens element, which can also provide the above functions. With the change of the distance between the first lens element 30 and the second lens element 40, the parallel light beam emitting from the light guide plate 20 can be focused by the first lens element 30 to form a divergent light beam which will be refracted by the second lens element 40 to form a parallel light beam with an enlarged projection plane and a reduced light intensity. The half value full angle of the light rays 100 emitting from the light emission surface 21, which is within 0-10 degrees, can be reduced within 0-1 degree after the adjustment and collimation of the two lens elements 30 and 40. The collimated beam angle of the respective light rays 100 of the parallel light beam emitting from the light guide plate 20 relative to the optical axis of the present invention, which is within the range of ±3 degrees can be reduced to the level of ±0.3 degrees after adjustment and collimation of the first lens element 30 and the second lens element 40.

With the above structure, the present invention can offer the following functions:

1. Optimal beam angle: after the collimation of the first lens element 30 and the second lens element 40, the parallel light beam of the light rays 100 emitting from the lens beam-concentrating device of the present invention has been collimated more than two times, thus offering the optimal beam angle, the collimated beam angle relative to the optical axis can be kept within the range of ±1 degree, and the half value full angle can be reduced within 0-3 degrees from 0-10 degrees, with such an accuracy, this light ray projection technology can satisfy the requirements of the beam projection of the micro photography and can also satisfy the requirements of the long-distance projection of a large search light or a portable electric torch.

2. Changeable projection plane: as known from the above description, the projection plane of the parallel light beam can change with the adjustment of the distance between the first lens element 30 and the second lens element 40, so that the first lens element 30 and the second lens element 40 can be disposed in the housing 50 to fix the distance therebetween, alternatively, the housing 50 can be designed to be a telescopic element for changing the distance between the first lens element 30 and the second lens element 40, but this is not the emphasis of the present invention, so further explanations are omitted herein, in addition, the projection plane of the light beam can be changed by enlarging or reducing the area of the light guide plate 20 directly, increasing or reducing the number of the light sources 10, or increasing or reducing the area of the first lens element 30 and the second lens element 40.

While we have shown and described various embodiments in accordance with the present invention, it is clear to those skilled in the art that further embodiments may be made without departing from the scope of the present invention.

What is claimed is:

1. A lens beam-concentrating device comprising:
plural light-emitting diode light sources;
a light guide plate having one lateral edge for mounting the respective light sources and having one end formed with an emission surface for emission of light rays emitting from the respective light sources; and
at least two lens elements being arranged adjacent to the light emission surface and located in order on an optical path where the light rays pass, after the light rays pass through the respective lens elements, the optical path of the light rays will be adjusted at least two times; wherein
a half value full angle of the light rays emitting from the light emission surface is within 0-10 degrees, after the light rays pass through the at least two lens elements, the half value full angle will be reduced within 0-3 degrees.

2. The lens beam-concentrating device as claimed in claim 1, wherein an collimated beam angle of light rays of a parallel beam emitting from the light guide plate relative to an optical axis, which is within the range of ±3 degrees, is reduced within the level of ±1 degree after the respective light rays are directed by the lens elements.

3. The lens beam-concentrating device as claimed in claim 1, wherein the light sources, the light guide plate and the lens elements are in order arranged in a housing, and the housing includes a chamber having a receiving space with an opening through which the light rays emits out of the housing, the housing is further provided with a power supply room for accommodation of a power supply, the power supply room is exteriorly connected with a switch.

4. The lens beam-concentrating device as claimed in claim 1, wherein the light guide plate is further provided with a light shielding element, the light shielding element includes a central light-transmission portion and a light shielding portion around the central light-transmission portion.

5. The lens beam-concentrating device as claimed in claim 1, wherein the light emission surface is arranged on one end surface of a total internal reflection layer, and the other end surface of the total internal reflection layer abuts against one end surface of a reflection layer, and this reflection layer is inclined or provided with a protruding reflective structure.

6. The lens beam-concentrating device as claimed in claim 1, wherein a first lens element in the lens elements is located closest to the light guide plate and in the form of a concave lens element, a second lens element in the lens elements is arranged adjacent to the first lens element and in the form of a convex lens element.

7. The lens beam-concentrating device as claimed in claim 1, wherein a first lens element in the lens elements is located closest to the light guide plate and in the form of a convex lens element, a second lens element in the lens elements is arranged adjacent to the first lens element and in the form of a convex lens element.

8. A lens beam-concentrating device comprising:
plural light-emitting diode light sources;
a light guide plate having one lateral edge for mounting the respective light sources and having one end formed with an emission surface for emission of light rays emitting from the respective light sources; and
two lens elements being arranged adjacent to the light emission surface and located in order on an optical path where the light rays pass, one of the two lens elements, which is located closest to the light emission surface of the light guide plate, being a first lens element in the form of a concave lens element, the other of the two lens elements being a second lens element in the form of a convex lens element, after passing through the two lens elements, the optical path of the light rays will be adjusted at least two times; wherein
a half value full angle of the light rays emitting from the light emission surface is within 0-10 degrees, after the light rays pass through the two lens elements, the half value full angle will be reduced within 0-3 degrees.

9. The lens beam-concentrating device as claimed in claim 8, wherein an collimated beam angle of light rays of a parallel beam emitting from the light guide plate relative to an optical axis, which is within the range of ±3 degrees, is reduced within the level of ±1 degree after the respective light rays are directed by the lens elements.

10. The lens beam-concentrating device as claimed in claim 8, wherein the light sources, the light guide plate and the lens elements are in order arranged in a housing, and the housing includes a chamber having a receiving space with an opening through which the light rays emits out of the housing, the housing is further provided with a power supply room for accommodation of a power supply, the power supply room is exteriorly connected with a switch.

11. The lens beam-concentrating device as claimed in claim 8, wherein the light guide plate is further provided with a light shielding element, the light shielding element includes a central light-transmission portion and a light shielding portion around the central light-transmission portion.

12. The lens beam-concentrating device as claimed in claim 8, wherein the light emission surface is arranged on one end surface of a total reflection layer, and the other end surface of the total reflection layer abuts against one end surface of a reflection layer, and this reflection layer is inclined or provided with a protruding reflective structure.

13. A lens beam-concentrating device comprising:
plural light-emitting diode light sources;
a light guide plate having one lateral edge for mounting the respective light sources and having one end formed with an emission surface for emission of light rays emitting from the respective light sources; and
two lens elements being arranged adjacent to the light emission surface and located in order on an optical path where the light rays pass, one of the two lens elements, which is located closest to the light emission surface of the light guide plate, being a first lens element in the form of a convex lens element, the other of the two lens elements being a second lens element in the form of a convex lens element, after passing through the two lens elements, the optical path of the light rays will be adjusted at least ten times; wherein
a half value full angle of the light rays emitting from the light emission surface is within 0-10 degrees, after the light rays pass through the two lens elements, the half value full angle will be reduced within 0-1 degrees.

14. The lens beam-concentrating device as claimed in claim 13, wherein an collimated beam angle of light rays of a parallel beam emitting from the light guide plate relative to an optical axis, which is within the range of ±3 degrees, is reduced within the level of ±0.3 degrees after the respective light rays are directed by the lens elements.

15. The lens beam-concentrating device as claimed in claim 13, wherein the light sources, the light guide plate and the lens elements are in order arranged in a housing, and the housing includes a chamber having a receiving space with an opening through which the light rays emits out of the housing, the housing is further provided with a power supply room for accommodation of a power supply, the power supply room is exteriorly connected with a switch.

16. The lens beam-concentrating device as claimed in claim 13, wherein the light guide plate is further provided with a light shielding element, the light shielding element includes a central light-transmission portion and a light shielding portion around the central light-transmission portion.

17. The lens beam-concentrating device as claimed in claim 13, wherein the light emission surface is arranged on one end surface of a total internal reflection layer, and the other end surface of the total internal reflection layer abuts against one end surface of a reflection layer, and this reflection layer is inclined or provided with a protruding reflective structure.
